(19) United States
(12) Patent Application Publication
(10) Pub. No.: US 2013/0000118 A1
(43) Pub. Date: Jan. 3, 2013

(54) Assembly Method of Liquid Crystal Panel

(75) Inventor: Zheng-Xing Xu, Shenzhen City (CN)

(73) Assignee: Shenzhen China Star Optpelectronics Technology Co., Shenzhen City, Guangdong (CN)

(21) Appl. No.: 13/377,147

(22) PCT Filed: Sep. 19, 2011
(86) PCT No.: PCT/CN2011/079825

§ 371 Date: Dec. 8, 2011

(30) Foreign Application Priority Data
Jun. 28, 2011 (CN) 201110176640.4

(51) Int. Cl. G02F 1/133; B23P 17/00

(52) U.S. Cl. 29/874

(57) ABSTRACT

The present invention discloses an assembly method of a liquid crystal panel, which comprises the following steps of: preparing an array substrate, and an upper surface of the array substrate is provided with a plurality of contact pads along side edges thereof; preparing a CF substrate, wherein an area of the upper surface of the CF substrate is smaller than that of the upper surface of the array substrate; and stacking the CF substrate upon the array substrate, so that the contact pads of the array substrate are exposed out of the CF substrate. When aligning the liquid crystal by the Photo-alignment. In the present invention, a process of cutting the CF substrate can be omitted, so as to decrease the manufacture cost.

### FIELD OF THE INVENTION

The present invention relates to an assembly method of a liquid crystal panel, and more particularly to an assembly method of a liquid crystal panel, which can align liquid crystal by the ultraviolet (UV) radiation and electrical connection.

### BACKGROUND OF THE INVENTION

A liquid crystal display (LCD) is a type of flat panel display (FPD) which displays images by the property of the liquid crystal material. In comparison with other display devices, the LCD has the advantages in lightweight, compactness, low driving voltage and low power consumption, and thus has already become the mainstream product in the whole consumer market. In a traditional process of LCD panel, it comprises a front-end array process, a mid-end cell process and a back-end modulation process. The front-end array process is used to produce thin-film transistor (TFT) substrates (also called array substrates) and color filter (CF) substrates; the mid-end cell process is used to combine the TFT substrate with the CF substrate, then fill liquid crystal into a space therebetween, and cut to form panels with a suitable product size; and the back-end modulation process is used to execute an installation process of the combined panel, a backlight module, a panel driver circuit, an outer frame, etc.

As mentioned above, in the mid-end cell process, it is necessary to finish the assembly of the TFT substrate and the CF substrate, and injects liquid crystal into the space between the TFT substrate and the CF substrate. Moreover, the injected liquid crystal further needs to be processed with an alignment technology, so as to control the alignment of the liquid crystal molecules. Nowadays, there are various types of liquid crystal alignment technology, for example, the polyimide-rubbing method and the Photo-alignment. The former is used to apply a velvet roller to the surface of macromolecular polyimide (PI), and process the contact-type of forward mechanical friction behavior. The energy provided from friction on macromolecular surface makes the main chain of macromolecules be forwardly aligned because of extension, so as to achieve the object to forwardly align liquid crystal; and the latter is to commonly inject liquid crystal molecules with the UV curing monomers into the panel, and radiates the panel with UV in a situation of applying a voltage, so as to control the alignment of liquid crystal molecules.

Referring now to FIGS. 1A and 1B, a cross-sectional side view of the traditional liquid crystal panel is illustrated in FIG. 1A; and a cross-sectional side view of the traditional liquid crystal panel after cutting side edges of CF substrate is illustrated in FIG. 1B. It should be noted that, for conveniently describing, the figures are shown in simplification, wherein some of members which are unrelated to the descriptions are omitted, so that the figures are schematic drawings. As shown in FIG. 1, a traditional liquid crystal panel 90 is assembled by stacking a CF substrate 92 upon an array substrate 91, and the upper surface of the array substrate 91 is provided with a plurality of contact pads 911 along the side edges thereof, and the space between the array substrate 91 and the CF substrate 92 will be filled with liquid crystal (not shown). Before the step of the liquid crystal alignment operation by the Photo-alignment, it must firstly cut the side edges of the CF substrate 92 (as shown in FIG. 1B), so that the contact pads 911 of the array substrate 91 can be exposed. Thus, when applying the UV radiation, it can use probes to supply electric power to the contact pads 911 of the array substrate 91 to twist liquid crystal, so as to achieve the object of alignment.

However, in the Photo-alignment process of the traditional liquid crystal panel, because it is necessary to cut the CF substrate 92 for exposing the contact pads 911, it has to add a cutting process, resulting in increasing the manufacture cost.

As a result, it is necessary to provide an assembly method of liquid crystal panel to solve the problems existing in the conventional technologies.

### SUMMARY OF THE INVENTION

The main object of the present invention is to provide an assembly method of liquid crystal panel to solve a problem that is necessary to add a cutting process to color filter (CF) substrate in conventional technology, resulting in relatively increasing the cost.

To achieve the above object, the present invention provides an assembly method of liquid crystal panel, which comprises the following steps:

preparing an array substrate, wherein the array substrate is a rectangular substrate which has a first length and a second length perpendicular to each other, and the upper surface of the array substrate is provided with a plurality of contact pads along side edges thereof for aligning liquid crystal;

preparing a CF substrate, wherein the CF substrate is a rectangular substrate which has a first length and a second length perpendicular to each other, and an area of the upper surface of the CF substrate is smaller than that of the upper surface of the array substrate; and

stacking the CF substrate upon the array substrate, wherein the direction of the first length of the CF substrate corresponds with the direction of the first length of the array substrate, and the direction of the second length of the CF substrate corresponds with the direction of the second length of the array substrate, and the contact pads of the array substrate are exposed out of the CF substrate.

To achieve the above object, the present invention further provides an assembly method of liquid crystal panel, which comprises the following steps:

preparing an array substrate, wherein the array substrate is a rectangular substrate which has a first length and a second length perpendicular to each other, and the upper surface of the array substrate is provided with a plurality of contact pads along side edges thereof for aligning liquid crystal;

preparing a CF substrate, wherein the CF substrate is a rectangular substrate which has a first length and a second length perpendicular to each other, and the area of the upper surface of the CF substrate is smaller than the area of the upper surface of the array substrate;

stacking the CF substrate upon the array substrate, wherein the direction of the first length of the CF substrate corresponds with the direction of the first length of the array substrate, and the direction of the second length of the CF substrate corresponds with the direction of the second length of the array substrate, and the contact pads of the array substrate are exposed out of the CF substrate; and

preparing a plurality of probes corresponding to the contact pads of the array substrate, supplying electric power to the contact pads through by the probes, and applying the ultraviolet radiation, so as to twist the liquid crystal to achieve the liquid crystal alignment.

In one embodiment of the present invention, before the step of stacking the CF substrate upon the array substrate, further comprising a step of injecting liquid crystal, wherein the liquid crystal is disposed on the upper surface of the array substrate by dropping.

In one embodiment of the present invention, after the step of stacking the CF substrate upon the array substrate, further comprising a step of injecting liquid crystal, wherein the liquid crystal is filled into a space between the array substrate and the CF substrate by vacuum injection.

In one embodiment of the present invention, after the steps of assembling the liquid crystal panel and injecting the liquid crystal, further comprising a step of aligning the liquid crystal: preparing a plurality of probes corresponding to the contact pads of the array substrate, supplying electric power to the contact pads through the probes, and applying the ultraviolet radiation, so as to twist the liquid crystal to achieve the liquid crystal alignment.

In one embodiment of the present invention, the first length of the array substrate is greater than the second length thereof, and the contact pads are disposed on the upper surface of the two side edges along the direction of the second length.

In one embodiment of the present invention, the second length of the CF substrate is smaller than the second length of the array substrate for at least two times of a width of the contact pads.

In one embodiment of the present invention, the first length of the CF substrate is smaller than the first length of the array substrate.

In one embodiment of the present invention, the first length of the array substrate is greater than the second length thereof, and the contact pads are disposed on the upper surface of the two side edges along the direction of the first length.

In one embodiment of the present invention, the first length of the CF substrate is smaller than the first length of the array substrate for at least two times of the width of the contact pads.

In one embodiment of the present invention, the second length of the CF substrate is smaller than the second length of the array substrate.

Hence, the assembly method of liquid crystal panel according to the present invention can expose the contact pads of the array substrate by correspondingly assembling the smaller CF substrate onto the greater array substrate for applying electric power during liquid crystal alignment. The assembly method of liquid crystal panel according to the present invention, a process of cutting the CF substrate can be omitted, so as to decrease the manufacture cost.

### DESCRIPTION OF THE DRAWINGS

FIG. 1A is a cross-sectional side view of the traditional liquid crystal panel;

FIG. 1B is a cross-sectional side view of the traditional liquid crystal panel after cutting side edges of color filter (CF) substrate;

FIG. 2A is a top view of an array substrate according to a first preferred embodiment of assembly method of the present invention;

FIG. 2B is a top view of CF substrate according to the first preferred embodiment of assembly method of the present invention;

FIG. 2C is a top view of an assembled liquid crystal panel according to the first preferred embodiment of assembly method of the present invention;

FIG. 3 is a cross-sectional side view of the assembled liquid crystal panel according to the first preferred embodiment of assembly method of the present invention;

FIG. 4 is a cross-sectional side view of an assembled liquid crystal panel according to a second preferred embodiment of assembly method of the present invention; and

FIG. 5 is a cross-sectional side view of an assembled liquid crystal panel according to a third preferred embodiment of assembly method of the present invention;

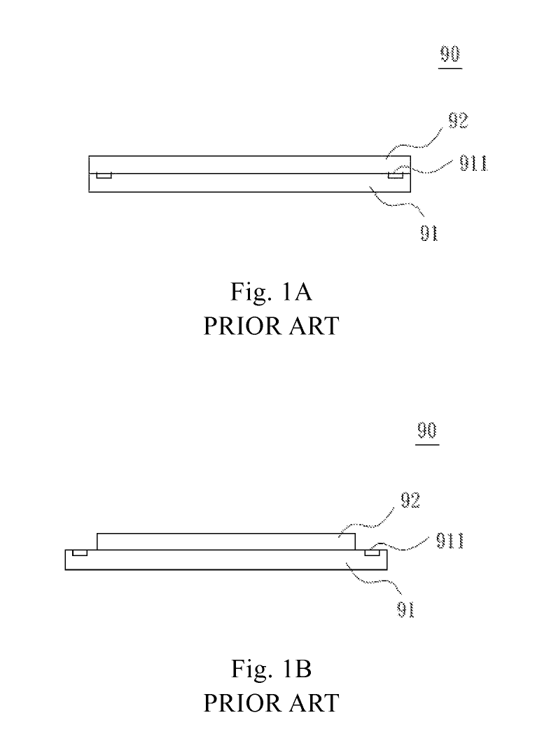

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

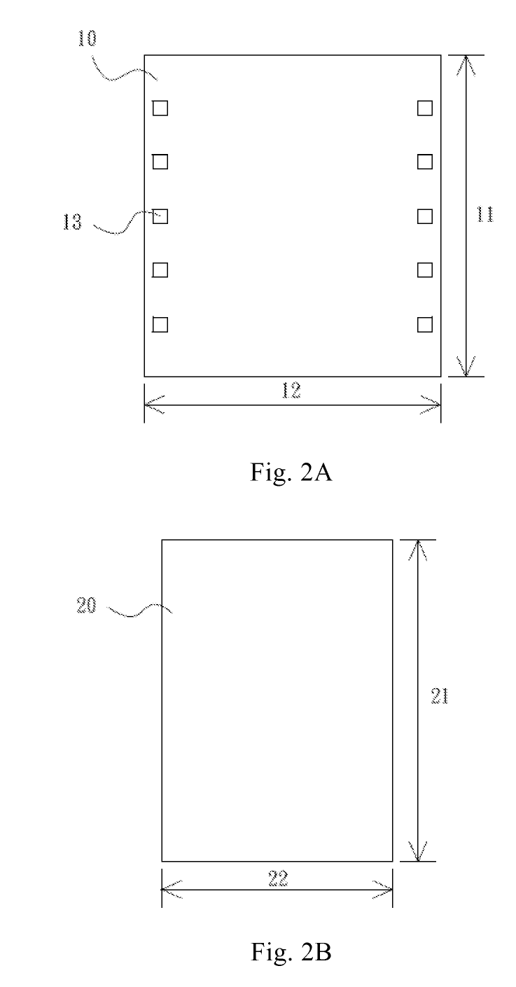

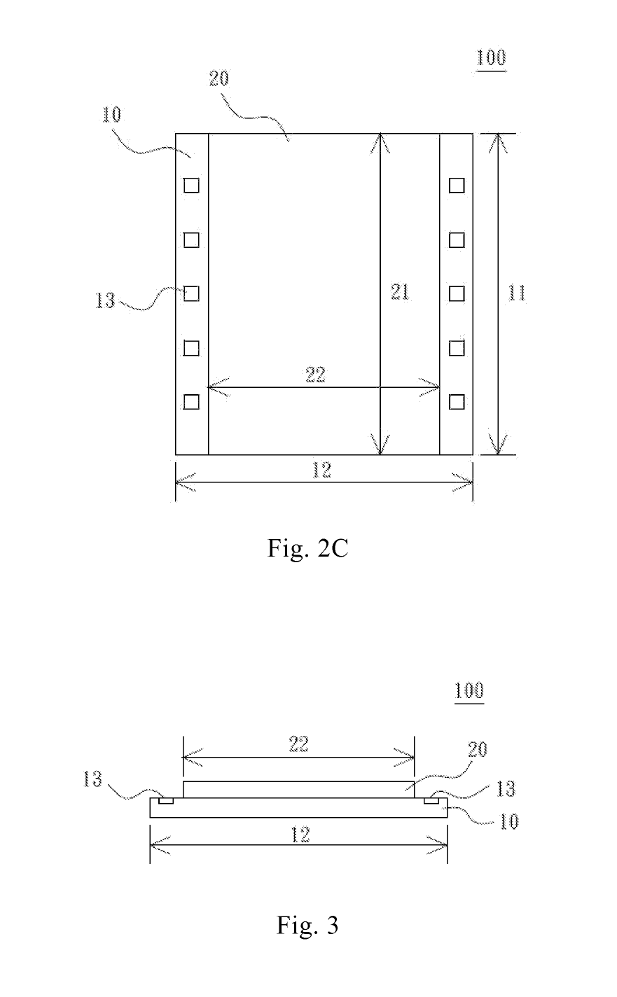

Referring now to FIGS. 2A, 2B, 2C and 3, a top view of an array substrate according to a first preferred embodiment of assembly method of the present invention is illustrated in FIG. 2A; a top view of a color filter (CF) substrate according to the first preferred embodiment of assembly method of the present invention is illustrated in FIG. 2B; a top view of an assembled liquid crystal panel according to the first preferred embodiment of assembly method of the present invention is illustrated in FIG. 2C; and a cross-sectional side view of the assembled liquid crystal panel according to the first preferred embodiment of assembly method of the present invention is illustrated in FIG. 3. It should be noted that, for conveniently describing, the figures are shown in simplification, wherein some of members which are not unrelated to the descriptions are omitted.

A liquid crystal panel 100 according to the first preferred embodiment of the present invention mainly comprises an array substrate 10 and a CF substrate 20, and assembly of the liquid crystal panel 100 is assembling the array substrate 10 and the CF substrate 20. The assembly method of the liquid crystal panel comprises the following steps:

Step 1: as shown in FIG. 2A, preparing an array substrate 10, wherein the array substrate 10 is a rectangular substrate which has a first length 11 and a second length 12 perpendicular to each other. The upper surface of the array substrate 10 is provided with a plurality of contact pads 13 along side edges thereof for aligning liquid crystal ;

Step 2: as shown in FIG. 2B, preparing a CF substrate 20, wherein the CF substrate 20 is a rectangular substrate which has a first length 21 and a second length 22 perpendicular to each other. An area of the upper surface of the CF substrate 20 is smaller than that of the upper surface of the array substrate 10; and

Step 3: as shown in FIGS. 2C and 3, assembling the liquid crystal panel 100 by stacking the CF substrate 20 upon the array substrate 10. In the case, A direction of the first length 21 of the CF substrate 20 corresponds with that of the first length 11 of the array substrate 10, and a direction of the second length 22 of the CF substrate 20 corresponds with that of the second length 12 of the array substrate 10, and the contact pads 13 of the array substrate 10 are exposed out of the CF substrate 20.

To continue, a space between the array substrate 10 and the CF substrate 20 has to be filled with the liquid crystal (not showed). There are two types of method for injecting the liquid crystal:

(a) Before the step of stacking the CF substrate 20 upon the array substrate 10(step 3), further comprises a step of injecting liquid crystal, wherein the liquid crystal is disposed on the upper surface of the array substrate by dropping (not shown);

(b) After the step (step 3) of stacking the CF substrate 20 upon the array substrate 10, further comprises a step of injecting liquid crystal, wherein the liquid crystal is filled into the space between the array substrate and the CF substrate 20 by vacuum injection (not shown).

Moreover, after the steps of assembling the liquid crystal panel 100 and injecting the liquid crystal, further comprising a step of aligning the liquid crystal: preparing a plurality of probes (not shown) corresponding to the contact pads 13 of the array substrate 10, supplying electric power to the contact pads 13 through the probes, and applying the ultraviolet (UV) radiation, so as to twist the liquid crystal to achieve the liquid crystal alignment.

As shown in FIGS. 2A, 2B, 2C and 3, the assembly method of liquid crystal panel according to the present invention can expose the contact pads 13 of the array substrate 10 by correspondingly assembling the smaller CF substrate 20 onto the greater array substrate 10. Because the assembly method of liquid crystal panel according to the present invention is not necessary to cut the CF substrate as prior art before align the liquid crystal by the Photo-alignment, The process of cutting the CF substrate 20 can be omitted, so as to decrease the manufacture cost.

Preferably, in this embodiment, the first length 11 of the array substrate 10 is greater than the second length 12 thereof. As shown in the FIG. 2C, a length of the array substrate 10 in up-down-direction is a little greater than a length thereof in left-right-direction. Besides, the contact pads 13 are disposed on the upper surface of the two side edges along the direction of the second length 12 of the array substrate 10 (the left-right-direction in Figs.). Moreover, the second length 22 of the CF substrate 20 is smaller than the second length 12 of the array substrate 10 for at least two times of a width of the contact pads, so that the contact pads 13 of the array substrate 10 can expose out of the CF substrate 20.

Furthermore, the size of the array substrate 10 and the CF substrate 20 is not limited in the present invention. In one exemplification, the first length 11 (length) of the array substrate 10 is 2500 mm, and the second length 12 (width) of the array substrate 10 is 2200 mm. Besides, the first length 21 (length) of the CF substrate 20 is 2500 mm, and the second length 22 (width) of the CF substrate 20 is 2100 mm. Therefore, the second length 22 of the CF substrate 20 (2100 mm) is smaller than the second length 12 of the array substrate 10 (2200 mm).

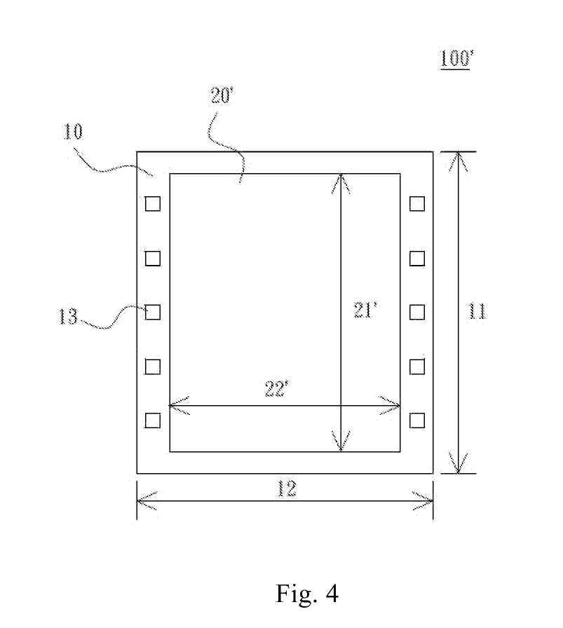

Referring now to FIG. 4, a cross-sectional side view of an assembled liquid crystal panel according to a second preferred embodiment of assembly method of the present invention is illustrated in FIG. 4. The structure of the liquid panel 100′ according to the second preferred embodiment of the present invention is substantially similar to the structure of the liquid panel 100 according to the first preferred embodiment of the present invention, so as to use similar terms and numerals, but the difference therebetween is that: in this embodiment, the first length 21′ of the CF substrate 20′ is further smaller than the first length 11 of the array substrate 10. Hence, the size of the CF substrate 20′ is more flexible for manufacture, and it is also can achieve the object to expose the contact pads 13.

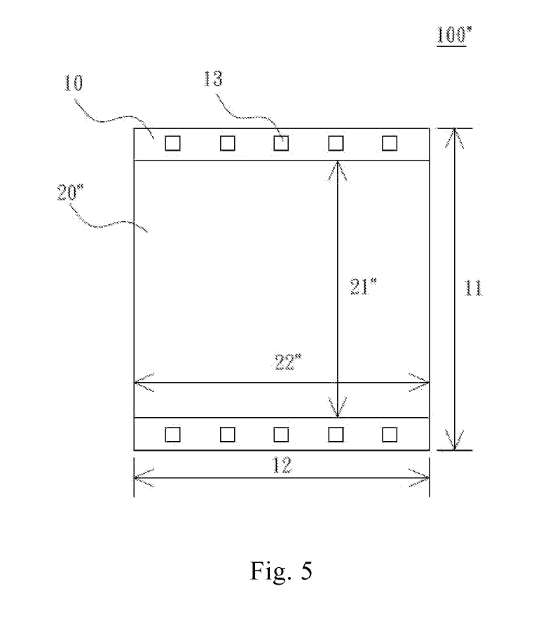

Referring now to FIG. 5, a cross-sectional of an assembled liquid crystal panel according side view according to a third preferred embodiment of assembly method of the present invention is illustrated in FIG. 5. The structure of the liquid panel 100″ according to the third preferred embodiment of the present invention is substantially similar to the structure of the liquid panel 100 according to the first preferred embodiment of the present invention, so as to use similar terms and numerals, but the difference therebetween is that: in this embodiment, the contact pads 13 are disposed on the upper surface of the two side edges along the direction of the first length 11 of the array substrate 10 (the up-down-direction in Figs.). Besides, the first length 21″ of the CF substrate 20″ is smaller than the first length 11 of the array substrate 10 for at least two times of the width of the contact pads, so that the contact pads 13 of the array substrate 10 can expose out of the CF substrate 20″

Moreover, the size of the array substrate 10 and the CF substrate 20″ is not limited in the present invention. In one exemplification, the first length 11 (length) of the array substrate 10 is 2500 mm, and the second length 12 (width) of the array substrate 10 is 2200 mm. Besides, the first length 21″ (length) of the CF substrate 20″ is 2400 mm, and the second length 22″ (width) of the CF substrate 20″ is 2200 mm. Therefore, the first length 21″ of the CF substrate 20″ (2400 mm) is smaller than the first length 11 of the array substrate 10 (2500 mm).

Furthermore, the second length 22″ of the CF substrate 20″ can be smaller than the second length 12 of the array substrate 10 (not shown), so that It is increased the flexible of manufacturing the CF substrate 20″ in the size.

As described above, in comparison with the traditional assembly method of liquid crystal panel before operation of the liquid crystal alignment of the Photo-alignment, it is necessary to manufacture by cutting the edges of the CF substrate. The assembly method of liquid crystal panel 100 according to the present invention can expose the contact pads 13 of the array substrate 10 by correspondingly assembling the smaller CF substrate 20 onto the greater array substrate 10, so that the process of cutting the CF substrate 20 can be omitted, so as to decrease the manufacture cost.

The present invention has been described with a preferred embodiment thereof and it is understood that many changes and modifications to the described embodiment can be carried out without departing from the scope and the spirit of the invention that is intended to be limited only by the appended claims.

1. An assembly method of a liquid crystal panel, wherein the assembly method comprises the following steps:
preparing an array substrate, wherein the array substrate is a rectangular substrate which has a first length and a second length perpendicular to each other, and an upper surface of the array substrate is provided with a plurality of contact pads along side edges thereof for aligning liquid crystal;
preparing a color filter (CF) substrate, wherein the CF substrate is a rectangular substrate which has a first length and a second length perpendicular to each other, and an area of the upper surface of the CF substrate is smaller than the area of the upper surface of the array substrate; and
stacking the CF substrate upon the array substrate, wherein the direction of the first length of the CF substrate corresponds with the direction of the first length of the array substrate, and the direction of the second length of the CF substrate corresponds with the direction of the second length of the array substrate, and the contact pads of the array substrate are exposed out of the CF substrate.

2. The assembly method of a liquid crystal panel according to claim 1, wherein before the step of stacking the CF substrate upon the array substrate, further comprising a step of injecting liquid crystal, wherein the liquid crystal is disposed on the upper surface of the array substrate by dropping.

3. The assembly method of a liquid crystal panel according to claim 1, wherein after the step of stacking the CF substrate upon the array substrate, further comprising a step of injecting liquid crystal, wherein the liquid crystal is filled into a space between the array substrate and the CF substrate by vacuum injection.

4. The assembly method of a liquid crystal panel according to claim 2, wherein after the steps of assembling the liquid crystal panel and injecting the liquid crystal, further comprising a step of aligning the liquid crystal: preparing a plurality of probes corresponding to the contact pads of the array substrate, supplying electric power to the contact pads through the probes, applying the ultraviolet radiation, so as to twist the liquid crystal to achieve the liquid crystal alignment.

5. The assembly method of a liquid crystal panel according to claim 1, wherein the first length of the array substrate is greater than the second length thereof, and the contact pads are disposed on the upper surface of the two side edges along the direction of the second length.

6. The assembly method of a liquid crystal panel according to claim 5, wherein the second length of the CF substrate is smaller than the second length of the array substrate for at least two times of a width of the contact pads.

7. The assembly method of a liquid crystal panel according to claim 5, wherein the first length of the CF substrate is smaller than the first length of the array substrate.

8. The assembly method of a liquid crystal panel according to claim 1, wherein the first length of the array substrate is greater than the second length thereof, and the contact pads are disposed on the upper surface of the two side edges along the direction of the first length.

9. The assembly method of a liquid crystal panel according to claim 8, wherein the first length of the CF substrate is smaller than the first length of the array substrate for at least two times of the width of the contact pads.

10. The assembly method of a liquid crystal panel according to claim 8, wherein the second length of the CF substrate is smaller than the second length of the array substrate.

11. An assembly method of a liquid crystal panel, wherein the assembly method comprises the following steps:
preparing an array substrate, wherein the array substrate is a rectangular substrate which has a first length and a second length perpendicular to each other, and the upper surface of the array substrate is provided with a plurality of contact pads along side edges thereof for aligning liquid crystals;
preparing a color filter (CF) substrate, wherein the CF substrate is a rectangular substrate which has a first length and a second length perpendicular to each other, and the area of the upper surface of the CF substrate is smaller than the area of the upper surface of the array substrate;
stacking the CF substrate upon the array substrate, wherein the direction of the first length of the CF substrate corresponds with the direction of the first length of the array substrate, and the direction of the second length of the CF substrate corresponds with the direction of the second length of the array substrate, and the contact pads of the array substrate are exposed out of the CF substrate; and
preparing a plurality of probes corresponding to the contact pads of the array substrate, supplying electric power to the contact pads through the probes, and applying the ultraviolet radiation, so as to twist the liquid crystal to achieve the liquid crystal alignment.

12. The assembly method of a liquid crystal panel according to claim 11, wherein before the step of stacking the CF substrate upon the array substrate, further comprising a step of injecting liquid crystal, wherein the liquid crystal is disposed on the upper surface of the array substrate by dropping.

13. The assembly method of a liquid crystal panel according to claim 11, wherein after the step of stacking the CF substrate upon the array substrate, further comprising a step of injecting liquid crystal, wherein the liquid crystal is filled into a space between the array substrate and the CF substrate by vacuum injection.

14. The assembly method of a liquid crystal panel according to claim 11, wherein the first length of the array substrate is greater than the second length thereof, and the contact pads are disposed on the upper surface of the two side edges along the direction of the second length.

15. The assembly method of a liquid crystal panel according to claim 14, wherein the second length of the CF substrate is smaller than the second length of the array substrate for at least two times of the width of the contact pads.

16. The assembly method of a liquid crystal panel according to claim 14, wherein the first length of the CF substrate is smaller than the first length of the array substrate.

17. The assembly method of a liquid crystal panel according to claim 11, wherein the first length of the array substrate is greater than the second length thereof, and the contact pads are disposed on the upper surface of the two side edges along the direction of the first length of the array substrate.

18. The assembly method of a liquid crystal panel according to claim 17, wherein the first length of the CF substrate is smaller than the first length of the array substrate for at least two times of the width of the contact pads.

19. The assembly method of a liquid crystal panel according to claim 17, wherein the second length of the CF substrate is smaller than the second length of the array substrate.

20. The assembly method of a liquid crystal panel according to claim 3, wherein after the steps of assembling the liquid crystal panel and injecting the liquid crystal, further comprising a step of aligning the liquid crystal: preparing a plurality of probes corresponding to the contact pads of the array substrate, supplying electric power to the contact pads through the probes, applying the ultraviolet radiation, so as to twist the liquid crystal to achieve the liquid crystal alignment.
